(19) United States
(12) Patent Application Publication
(10) Pub. No.: US 2021/0294066 A1
(43) Pub. Date: Sep. 23, 2021

(54) LENS UNIT AND CAMERA MODULE

(71) Applicant: MAXELL, LTD., Kyoto (JP)

(72) Inventors: Hiroyuki HIRATA, Kyoto (JP); Akira INABA, Kyoto (JP); Osamu ISHIZAKI, Kyoto (JP)

(73) Assignee: Maxell, Ltd., Kyoto (JP)

(21) Appl. No.: 17/056,893

(22) PCT Filed: May 24, 2019
(86) PCT No.: PCT/JP2019/020690

§ 371 Date: Nov. 19, 2020

(30) Foreign Application Priority Data
May 24, 2018 (JP) 2018-099530

(51) Int. Cl. G02B 7/02; H05B 1/02; H05B 3/14

(52) U.S. Cl. CPC G02B 7/028; G02B 7/021; H05B 2203/013; H05B 3/145; H05B 1/0288

(57) ABSTRACT

A lens unit has a snow melting function without causing an increase in size. The lens unit includes: a cylindrical lens barrel; and a plurality of lenses arranged side by side along the axial direction of the lens barrel on the inner peripheral side of the lens barrel. A heater unit that generates a heat when energized is provided between the flange portion (flat portion) of the lens disposed on the most object side of the lens barrel and the flange portion (flat portion) of the lens adjacent to the lens.

The present invention relates to a lens unit and a camera module.

### BACKGROUND ART

There have been known cameras installed outdoors, such as surveillance camera and in-vehicle camera. In such an outdoor camera, ice and snow may adhere to the front surface of the lens during snowfall. In addition, when outside air temperature falls below freezing, the front surface of the lens may freeze and frost may adhere to the lens. In such case, an image captured becomes unclear due to the deposits on the front surface of the lens, and the imaging performance of camera will deteriorate.

In recent years, a camera (in-vehicle camera) is often installed in a vehicle, and an image captured by the in-vehicle camera is used to provide functions such as an automatic braking function and an automatic driving function. These functions are functions for controlling the running of the vehicle, and deterioration of the imaging function of an in-vehicle camera may lead to the occurrence of an accident or the like. For this reason, there has been a demand for developing a camera having a snow melting function that melts the deposits adhering to the front surface of the lens. As an example of a camera having a snow melting function, there is, for example, a camera disclosed in Patent Document 1.

### CITATION LIST

Patent Document
Patent Document 1: Japanese Unexamined Patent Application Publication No. 2006-10983.

### SUMMARY OF INVENTION

### Technical Problems

A camera disclosed in Patent Document 1 includes CCD, circuit elements or the like that generate a heat during operation. Such a camera is equipped with a fan that circulates the air inside the camera to prevent dew condensation on the cover glass installed in front of the lens. However, since such a camera is equipped with a fan, there is a problem that the size of the camera is large. Accordingly, such a camera cannot be easily mounted in a vehicle, especially when amounting space is limited in a vehicle.

The present invention has been accomplished in view of the above circumstances, and it is an object of the invention to provide a lens unit and a camera module having a snow melting function without causing an increase in size.

### Solution to Problems

In order to solve the above problems, the lens unit of the present invention includes a cylindrical lens barrel and a plurality of lenses arranged side by side along an axial direction of the lens barrel on an inner peripheral side of the lens barrel, wherein

a heater unit that generates a heat when energized is provided between a flat portion of a first lens arranged on the most object side of the lens barrel and a flat portion of a second lens adjacent to the first lens.

According to such a configuration, since the heater unit is provided between the flat portion of the first lens and the flat portion of the second lens, it is possible to realize a lens unit having a snow melting function without increasing the size.

In the above configuration of the present invention, the heater unit includes:

a conductive carbon film having a self-temperature control function and a light-blocking function; and

a circuit pattern for energizing the conductive carbon film.

According to such a configuration, it is possible to realize a lens unit provided with a heater unit having a self-temperature control function and a light-blocking function without causing an increase in size.

In the above configuration of the present invention, the circuit pattern has a comb-like shape including a plurality of protruding portions protruding in the radial direction, and arranged at equal intervals along the circumferential direction.

According to such a configuration, since the entire heater unit generates heat uniformly, it is possible to realize an unbiased snow melting function, thereby making it possible to more reliably prevent a deterioration in imaging performance.

In the above configuration of the present invention, the heater unit includes:

a flexible substrate on which a heater circuit has been formed; and

a thermistor mounted on the flexible substrate and having a self-temperature control function.

According to such a configuration, it is possible to realize a lens unit provided with a heater unit having a self-temperature control function without causing an increase in size.

In the above configuration of the present invention, the heater unit includes:

a flexible substrate;

a conductive carbon film formed on the flexible substrate and having a self-temperature control function and a light-blocking function; and

a circuit pattern electrically connected to the flexible substrate and capable of energizing the conductive carbon film.

According to such a configuration, it is possible to realize a lens unit provided with a heater unit having a self-temperature control function and a light-blocking function without causing an increase in size.

In the above configuration of the present invention, the circuit pattern has a comb-like shape including a plurality of protruding portions protruding in the radial direction, and arranged at equal intervals along the circumferential direction.

According to such a configuration, since the entire heater unit generates a heat uniformly, it is possible to realize an unbiased snow melting function, making it possible to more reliably prevent a deterioration in imaging performance.

In the above configuration of the present invention, the heater unit is formed of ceramics having a self-temperature control function.

According to such a configuration, a lens unit provided with a heater unit having a self-temperature control function can be realized without causing an increase in size.

In the above configuration of the present invention, the heater unit has a PTC characteristic, and has a Curie temperature which is 80° C. or higher and 120° C. or lower.

Since the temperature of the Curie point is 80° C. or higher and 120° C. or lower, the first lens located on the object side of the heater unit can be heated in a short time from the start of energization, thereby realizing a snow melting function. Further, it is possible to prevent the second lens located on the image side of the heater unit from being deformed due to a high temperature of the heater unit. As a result, it is possible to prevent a deterioration in optical performance which will otherwise be caused due to deformation of the second lens.

In the above configuration of the present invention, the heater unit is formed in an annular shape, and includes:

an inner peripheral side electrode pattern provided along the inner peripheral portion and the inner peripheral side surface of the image side surface of the heater unit; and

an outer peripheral side electrode pattern provided along the outer peripheral portion and the outer peripheral side surface of the image side surface of the heater unit;

lead wires are respectively adhered to the end portion of the inner peripheral electrode pattern and the end portion of the outer peripheral electrode pattern.

According to such a configuration, the contact area between the electrode pattern and the heater unit can be increased. As a result, it is possible for the heater unit to efficiently produce a heat.

In the above configuration of the present invention, lens barrel has a through hole for drawing a lead wire connected to the heater unit to the outside of the lens barrel through an opening formed on the outer peripheral surface of the lens barrel;

the lead wire is fixed to the opening on the outer peripheral surface side of the lens barrel by an adhesive or a fixing member.

Since the lead wire is fixed to the opening by an adhesive or a fixing member, even if the lead wire is pulled, it is still possible to prevent a force from being applied to a joint between the lead wire and the heater unit, and to improve a resistance against a pulling of the lead wire. As a result, even if the lead wire is pulled in the manufacturing process of the camera module, it is still possible to prevent the lead wire from coming off the heater unit.

In the above configuration of the present invention, there are two through holes provided in two positions, with one lead wire inserted into one through hole.

According to such a configuration, since the through holes are provided at two places, it is possible to prevent the outer peripheral surface of the lens barrel containing the lens from being easily bent outwardly in the radial direction. As a result, for example, when the through hole is an elongated hole at only one place, it is possible to prevent the outer peripheral surface of the lens barrel from easily bending outwardly in the radial direction, thereby avoiding a problem of allowing a water or the like to enter the lens barrel.

In the above configuration of the present invention, the fixing member is formed in a substantially cylindrical shape, and is inserted into the opening in a state where the lead wire has been inserted into the fixing member.

By using a substantially cylindrical fixing member, the lead wire can be fixed even when a fluororesin electric wire such as PTFE is used as the lead wire.

In the above configuration of the present invention, the fixing member is formed in a tapered shape using an elastically deformable material, such that the outer diameter thereof becomes smaller from one end to the other, and is inserted into the opening from an end having a smaller diameter, with the inner diameter thereof becoming smaller while being inserted into the opening.

In this way, by using the fixing member formed in a tapered shape and elastically deformable, when the fixing member is inserted into the opening, the inner diameter will become smaller and the lead wire will be tightened. As a result, the lead wire can be securely fixed, making it possible to prevent the lead wire from coming off the heater unit.

In the above configuration of the present invention, the thickness of the heater unit is such that a distance between the flat portion of the first lens and the flat portion of the second lens is 0.5 mm or less; a plurality of the lenses form an ultra-wide-angle lens assembly having a horizontal angle of view which is larger than 180°.

According to such a configuration, it is possible to realize a high-performance ultra-wide-angle lens having a snow melting function and a horizontal angle of view which is larger than 180°.

A camera module according to the present invention comprises: a lens unit as described above; and an imaging element that captures an image formed by the lens unit.

According to such a configuration, it is possible for the camera module to have the same effect as the lens unit of the present invention described above.

A camera module according to the present invention comprises:

a lens unit as described above;

an imaging element that captures an image formed by the lens unit;

a camera case that covers the periphery of the lens unit while exposing an end of the lens unit on the object side.

In particular, an O-ring is disposed between the camera case and the flange portion formed on the outer peripheral surface of the lens barrel to form a seal portion;

the opening of the through hole on the outer peripheral surface side of the lens barrel is provided on the image side of the seal portion in the axial direction of the lens barrel.

According to such a configuration, since the opening of the through hole on the outer peripheral surface side of the lens barrel is on the image side of the seal portion, the position of the opening will be located inside the camera case in which airtightness is ensured. Therefore, water will not enter the lens barrel through the opening, and it is not necessary to insulate the heater unit. As a result, it is possible to realize a low cost and an improvement in productivity for camera manufacturing.

### Effects of the Invention

According to the present invention, it is possible to realize a lens unit and a camera module having a snow melting function without causing an increase in size.

### DESCRIPTION OF THE DRAWINGS

FIG. 1 is a cross-sectional view showing a lens unit according to a first embodiment of the present invention.

FIG. 2 (a) is a diagram explaining a heater unit, FIG. 2 (b) is a diagram explaining a PTC function.

FIG. 3 is a diagram showing a modified example of a wiring portion.

FIG. 4(a) is a cross-sectional view showing a lens unit according to a second embodiment of the present invention. FIGS. 4 (b), 4(c) are views explaining a relationship between the holes and the wiring inside the lens barrel.

FIG. 5 is a diagram for explaining the heater unit.

FIG. 6 is a cross-sectional view showing a lens unit according to a third embodiment of the present invention.

FIG. 7 is a diagram explaining a heater unit.

FIG. 8 is a cross-sectional view showing a lens unit according to a fourth embodiment of the present invention.

FIG. 9 is a cross-sectional view showing a modified example using a cap, based on lens units according to the first to fourth embodiments.

FIG. 10 is a cross-sectional view showing a lens unit according to a fifth embodiment of the present invention.

FIG. 11 provides views showing a heater unit, FIG. 11 (a) is a view seen from the image side, FIG. 11(b) is a cross-sectional view taken along G-G line in FIG. 11 (a).

FIG. 12 is a graph showing a relationship among an electric current supplied to a heater unit, an elapsed time from the start of heater energization, and a surface temperature of PTC heater and lens, when the Curie point of the heater unit is 80° C. and an environment is under a room temperature.

FIG. 13 is a graph showing a relationship among an electric current supplied to a heater unit, an elapsed time from the start of heater energization, and a surface temperature of PTC heater and lens, when the Curie point of the heater unit is 80° C. and an environment is under a temperature of −30° C.

FIG. 14 is a graph showing a relationship among an electric current supplied to a heater unit, an elapsed time from the start of heater energization, and a surface temperature of PTC heater and lens, when the Curie point of the heater unit is 120° C. and an environment is under a room temperature.

FIG. 15 is a graph showing a relationship among an electric current supplied to a heater unit, an elapsed time from the start of heater energization, and a surface temperature of PTC heater and lens, when the Curie point of the heater unit is 120° C. and an environment is under a temperature of −30° C.

FIG. 16 provides axial cross-sectional views showing a camera module including a lens unit, FIG. 16(a) is a sectional view passing through a first through-hole, FIG. 16(b) is a sectional view passing through a second through hole.

FIG. 17(a) is a view showing a part of the lens barrel as seen from the object side of lens barrel, FIG. 17(b) is a view of the lens barrel as viewed from one side.

FIG. 18 is a side view of the lens unit in a state where the lead wires have been pulled out.

FIG. 19 is an axial cross-sectional view of the lens unit in a state where a fixing member has been inserted into the opening of a through hole of the lens barrel.

FIG. 20 provides views showing a fixing member, FIG. 20(a) is a view showing a first example of the fixing member, FIG. 20 (b) is a view showing a second example of the fixing member, FIG. 20 (c) is a view showing a third example of the fixing member.

### DESCRIPTION OF EMBODIMENTS

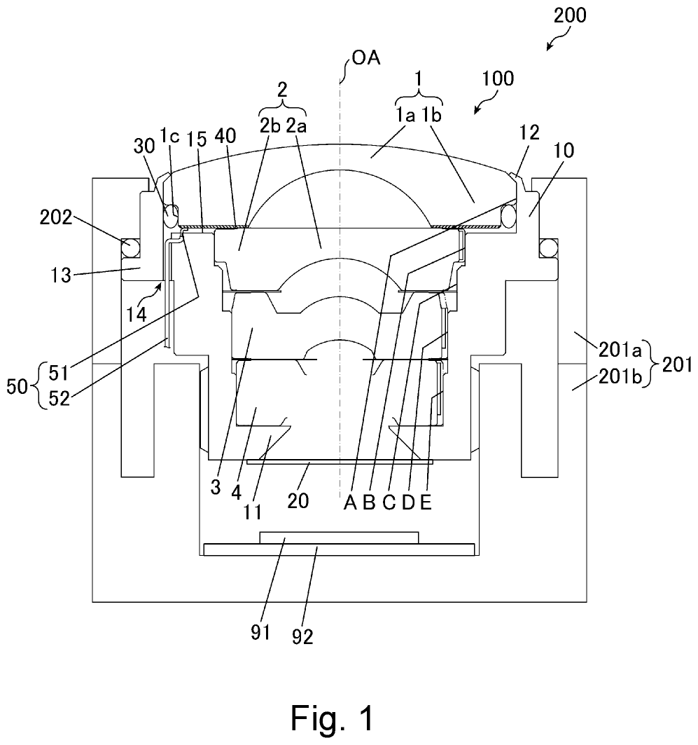

Hereinafter, the first embodiment of the present invention will be described with reference to the drawings. FIG. 1 is an axial sectional view of a lens unit 100 according to the first embodiment. In FIG. 1, hatching portions indicating cross sections are omitted. The lens unit 100 produces an image of an object on the image side thereof, and is used in, for example, an in-vehicle camera. Some in-vehicle cameras are mounted on the side mirrors of vehicles to take images of areas behind the vehicles. As shown in FIG. 1, the lens unit 100 includes a camera module 200 together with a camera case 201, an O-ring 202, and the like.

As shown in FIG. 1, the lens unit 100 includes lenses 1-4, a lens barrel 10, an optical filter 20, an O-ring 30, a heater unit 40, a wiring portion 50, and the like.

In the lens barrel 10, lenses 1-4 forming one lens group are arranged side by side along the axial direction of the lens barrel 10. Here, the lenses 1-4 are arranged in a manner such that their optical axes are aligned with each other and are arranged along the optical axis. At this time, the axis of the lens barrel 10 and the optical axis of the lens group (referred to as optical axis OA) are substantially coincident with each other. Hereinafter, the term optical axis OA refers to the optical axes of the lenses 1-4 and the optical axis of the lens group.

The lens barrel 10 is disposed such that one end thereof in the axial direction faces an imaging sensor 91 as the image side, and the other end thereof in the axial direction is disposed to face an object as the object side. In the present embodiment, the lens 4 side is the image side and the lens 1 side is the object side.

Lenses 1-4 are arranged inside the lens barrel 10 in the order of lens 1, lens 2, lens 3, and lens 4 from the object side to the image side. The optical filter 20 is disposed at the end of the lens barrel 10 on a side (image side) where the lenses 1-4 form an image. The optical filter 20 is arranged for the purpose of removing a specific frequency component.

The lens barrel 10 has a cylindrical shape. The lens barrel 10 itself is made of resin. However, description will be given later to describe an example in which the lens barrel 10 is made of metal. The inner diameter of the lens barrel 10 gradually decreases from the object side to the image side. Here, the inner peripheral surface of the lens barrel 10 is defined as an inner peripheral surface A, an inner peripheral surface B, an inner peripheral surface C, an inner peripheral surface D, and an inner peripheral surface E, arranged from the object side to the image side. A support portion 11 is formed on the image side of the inner peripheral surface E, providing a portion protruding inwardly in the radial direction so that the inner diameter thereof becomes smaller. Here, the support portion 11 is in contact with the image-side surface of the flange portion of the lens 4. The flange portion is a portion formed on the outer peripheral side of the effective diameter of the lens, including a flat surface portion.

The lens barrel 10 includes a holding portion 12 formed at one end of the barrel on the object side thereof, abutting on the outer peripheral portion of the object side surface of the lens 1. The holding portion 12 is a portion formed by caulking after necessary parts are received into the lens barrel 10. The inner diameter of the holding portion 12 is smaller than the outer diameter of the lens 1. The parts housed within the lens barrel 10 are supported such that they are sandwiched between the support portion 11 and the holding portion 12. In other words, the parts housed inside the lens barrel 10 are held in a state of being pressed toward the support portion 11 by the holding portion 12, thus preventing gaps from being formed between the parts.

Lenses 1-4 are circular lenses that are fitted into the lens barrel 10. The lens 1 is made of glass, and the lenses 2-4 are made of resin. When the outer peripheral surfaces of the lenses 1-4 are in contact with the inner peripheral surface of the lens barrel 10, the lenses 1-4 will be positioned in a direction orthogonal to the optical axis direction of the lens barrel 10.

A reduced diameter portion 1c, which is a portion having a smaller diameter than other portions, is formed on the image side of the outer peripheral surface of the lens 1. An O-ring 30 is disposed between the reduced diameter portion 1c and the inner peripheral surface A of the lens barrel 10. The O-ring 30 is made of rubber and seals a gap to prevent water, dust, or the like from entering the lens barrel 10.

A flange portion 13 which is a plate-shaped portion projecting outward in the radial direction is formed on the outer peripheral surface of the lens barrel 10. The camera case 201 is composed of an upper camera case 201a and a lower camera case 201b, covering other parts of the lens unit 100 while exposing the object-side end of the lens unit 100 to the outside through a circular opening. The O-ring 202 is made of rubber, and to ensure an airtightness inside the camera case 201, is disposed between the outer peripheral surface of the lens barrel 10, the flange portion 13 of the lens barrel 10, and the inner peripheral surface of the camera case 201.

The lens 1 (first lens) includes a lens portion 1a and a flange portion 1b. The flange portion (flat portion) is a portion formed on the outer peripheral side of the effective diameter of the lens, including a flat portion. The flange portion 1b is provided with a flat portion on the image side.

The lens 2 (second lens) includes a lens portion 2a and a flange portion 2b. The flange portion 2b is provided with flat surface portions which are located on both the object side and the image side.

A heater unit 40, which will be described later, is provided on the image-side surface of the flange portion 1b of the lens 1. Further, the heater unit 40 has apart of its surface on the image side which comes into contact with the surface of the flange portion 2b of the lens 2 on the object side thereof. That is, the heater unit 40 is provided at a position between the flange portion 1b of the lens 1 and the flange portion 2b of the lens 2. In fact, the heater unit 40 is provided at a position that does not affect the imaging performance of the lens unit 100.

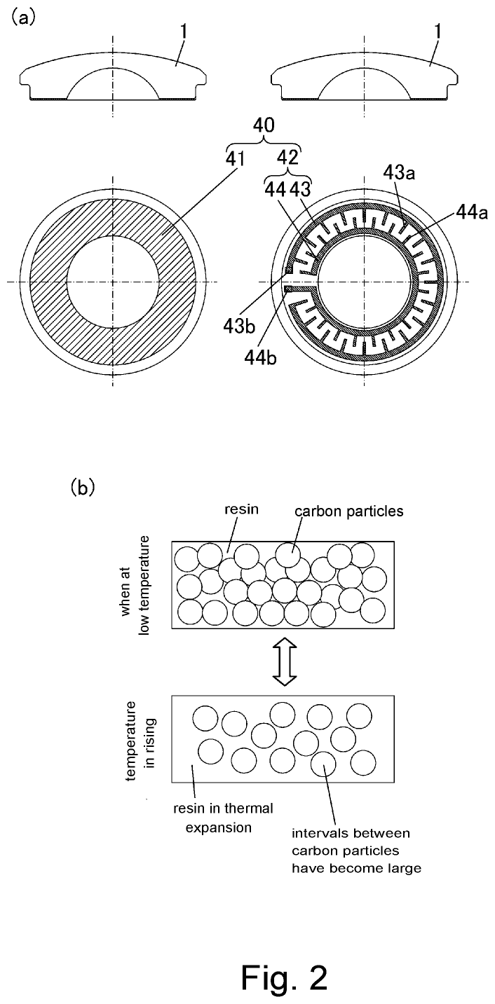

FIG. 2(a) is a diagram explaining the heater unit 40. As shown, the heater unit 40 includes a conductive carbon film 41 and a circuit pattern 42. The conductive carbon film 41 is applied to the image side surface of the flange portion 1b of the lens 1. Further, the conductive carbon film 41 may also be printed to the portion.

The circuit pattern 42 is printed and formed on the conductive carbon film 41 on the flange portion 1b of the lens 1. Here, the printing may be performed by, for example, a screen printing machine. The circuit pattern 42 includes electrodes formed into a circular shape, including an outer peripheral side circuit pattern 43 and an inner peripheral side circuit pattern 44. The circuit pattern 42 energizes the conductive carbon film 41. The outer peripheral side circuit pattern 43 includes a plurality of protruding portions 43a protruding inwardly in the radial direction, forming into a comb shape. The inner peripheral side circuit pattern 44 includes a plurality of protruding portions 44a protruding outwardly in the radial direction, forming into a comb shape. The plurality of protruding portions 43a and the plurality of protruding portions 44a are formed alternately along the circumferential direction at equal intervals. The outer peripheral side circuit pattern 43 and the inner peripheral side circuit pattern 44 are formed in a manner such that a distance between every two adjacent electrodes is constant. In this way, the current values will be equal over the entire surface of the circuit patterns. As a result, it is possible to suppress a temperature unevenness when the conductive carbon film 41 generates a heat, thus ensuring an even temperature distribution. In this way, since the temperature unevenness occurring at the time the conductive carbon film 41 generates a heat will affect the symmetry of the optical performance and will cause a deterioration in the optical performance, it is preferable that the conductive carbon film 41 be formed in a symmetric shape except for the end portion of the circuit pattern 42.

The heater unit 40 is formed as follows.

First, 60 wt % of EVA (vinyl acetate and polyethylene copolymer) having a vinyl acetate content of 17 wt % and 40 wt % of carbon black are kneaded for about 10 minutes while being heated at a temperature of 120° C., thereby obtaining a mixture X. In kneading, for example, a planetary mixer is used.

Next, the mixture X is dispersed and stirred with a tetralin solvent to obtain an ink Y diluted such that the solvent clay becomes 3500 centipoise.

Next, while rotating the lens 1 using a glass lens blackening machine, ink Y is applied to the image side of the flange portion 1b of the lens 1 so that the thickness is 15 μm. After such an applying, the ink Y is dried to form the conductive carbon film 41.

Next, a screen printing machine is used to apply a silver paste to forma circuit pattern 42, using the blackened surface (conductive carbon film 41) of the lens 1 as a base, thereby forming a circuit pattern 42 which is a comb-shaped electrode.

The conductive carbon film 41 has a conductive function and generates a heat when energized. That is, the conductive carbon film 41 has a function as a heater. Further, the conductive carbon film 41 has a light-blocking function, preventing an unnecessary light from entering the lens barrel 10 and thus preventing undesired ghosts and flares.

Moreover, the conductive carbon film 41 has a PTC (Positive Temperature Coefficient) function, that is a self-temperature control function. Therefore, a heating temperature can be kept constant.

FIG. 2(b) is a diagram for explaining the PTC function. At normal temperatures (including a low temperature), carbon black molecules are in close mutual contact and carbon black material as a whole has a low resistance, so that an electric current flows smoothly. On the other hand, when the temperature rises, the EVA expands and the carbon black molecules are mutually separated and non-contacted, so that the resistance increases and the current becomes difficult to flow, thus causing a stop in temperature rising. When an elevated temperature decreases and returns from the high temperature to the normal temperature, the EVA contracts and the current begins to flow as before. By repeating such a process, the heating temperature can be kept constant. On the other hand, PTC material having PTC function is not limited to the organic material shown in FIG. 2(b). For example, it is also possible to use an inorganic material such as ceramics obtained by adding an additive such as a rare earth into barium titanate.

A material having PTC function is such that its resistance rapidly increases once temperature rises from a room temperature (25° C.) and rises above a certain value. A temperature at which this increase begins is called Curie temperature (Tc), and is defined as a temperature that doubles a resistance at 25° C.

Returning to FIG. 1, description will be given to a wiring portion 50.

The wiring portion 50 is provided to supply an electric power to the heater unit 40. The wiring portion 50 includes a spring member 51 and a lead wire 52. In this embodiment, two spring members 51 are used which are each connected to an end portion 43b of the outer peripheral side circuit pattern 43 and an end portion 44b of the inner peripheral side circuit pattern 44 shown in FIG. 2.

The spring member 51 is made of phosphor bronze and has an electrical conductivity. Further, the spring member 51 has an elastic force. The end of the spring member 51 on the side opposite to the connection side with the circuit pattern 42 is connected to the lead wire 52 (shown in FIG. 1). The lead wire 52 is a metal wire for passing an electric current, and is coated with PVC (polyvinyl chloride). On the other hand, it is also possible for the coating material to be PTFE (fluororesin) having an excellent heat resistance.

Next, the wiring of the wiring portion 50 will be described as follows.

A stepped portion 15 which is a stepped surface in the axial direction is formed at the boundary portion between the inner peripheral surface A and the inner peripheral surface B of the lens barrel 10. The stepped portion 15 of the lens barrel 10 is provided with a hole 14 for communicating the inside of the lens barrel 10 and the outside of the lens barrel 10 in parallel with the axial direction of the lens barrel 10. Here, the hole 14 is provided to guide the lead wire 52 to the inside of the lens barrel 10.

The opening of the hole 14 on the outer side of the lens barrel 10 is provided at a position on the image side of the seal portion between the camera case 201 and the O-ring 202, along the axial direction of the lens barrel 10. Here, since the interior of the camera case 201 is ensured to be airtight, water does not enter the lens barrel 10 through the hole 14. As a result, it is not necessary to insulate the heater unit 40.

The lead wire 52 is guided from the outside of the lens barrel 10 into the lens barrel 10 through the hole 14, with one end of lead wire connected to the spring member 51. Although not shown, the other end of the lead wire 52 is connected to a wiring board 92 provided with a power supply circuit for supplying electricity to the heater unit 40. Here, the wiring board 92 is configured to be provided within the camera case 201.

At the time of assembling, the lenses 2-4 are inserted into the lens barrel 10. Then, the lens 1 on which the heater unit 40 has been formed is incorporated into the lens barrel 10. The spring member 51 that is electrically connected to the heater unit 40 of the lens 1 is embedded into the lens barrel 10. The spring member 51 is connected to the lead wire 52, and the lead wire 52 is then led out to the outside of the lens barrel 10 through the hole 14 of the lens barrel 10. In this way, the inside and the outside of the lens barrel 10 are electrically connected.

When the lens 1 is incorporated into the lens barrel 10, the spring member 51 and the heater unit 40 of the lens 1 are mechanically contacted with each other and become electrically conductive. Therefore, the troublesome connecting work of the lead wire becomes unnecessary, thus ensuring an improved performance in assembling.

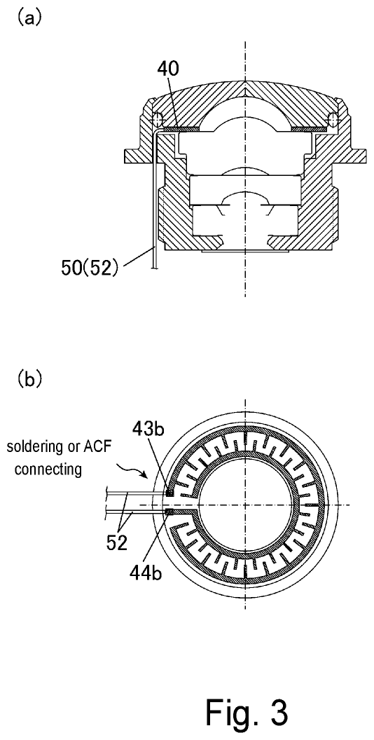

The above description has been given to an example in which the spring member 51 is used to form a connection between the circuit pattern 42 and the lead wire 52. In other words, the above description shows an example in which the wiring portion 50 includes the spring member 51 and the lead wire 52. However, such description should not form any limitation to the present invention and it is also possible for the wiring portion 50 to include only lead wire 52. FIGS. 3 (a) and 3 (b) are views showing a case where the wiring portion 50 includes only lead wire 52. In this case, the end portions 43b, 44b of the circuit pattern 42 and the lead wire 52 are connected by soldered or ACF (Anisotropic Conductive Film).

The camera module 200 includes a lens unit 100, a camera case 201, an O-ring 202, an imaging sensor 91, a wiring board 92, a signal processing circuit, a flexible wiring sheet, a connector, and the like. In fact, the camera module 200 includes at least a lens unit 100 and an imaging sensor 91. The imaging sensor 91 is disposed within the camera case 201. The imaging sensor 91 is disposed on the image side of the lens unit 100 so as to capture an image formed in the lens unit 100.

The camera module 200 operates as follows. A light incident from the object side is incident on the imaging sensor 91 through the lens group of the lens unit 100. The imaging sensor 91 converts the incident image into an electric signal. The signal processing circuit performs a signal processing (A/D conversion, image correction, or the like) on the electric signal fed from the imaging sensor 91. The electric signal fed from the signal processing circuit is sent to an external electronic device through a flexible wiring sheet and a connector.

When receiving an electric power supplied through the wiring portion 50, the heater unit 40 will generate a heat upon being energized. The heat from the heater unit 40 is then transferred to the lens 1 and the lens 2. When the temperature of the lens 1 rises, ice/snow or frost adhering to the object-side surface of the lens 1 (front surface of the lens 1) will melt.

The lens 1 is made of glass and has a thermal conductivity of 0.5 (W·m⁻¹·K⁻¹) or more and 1.5 (W·m⁻¹·K⁻¹) or less. On the other hand, the lens 2 is made of plastic and has a thermal conductivity of less than 0.5 (W·m⁻¹·K⁻¹). Namely, the lens 1 is configured to have a higher thermal conductivity than the lens 2. The heater unit 40 can efficiently transfer a heat to the object side and efficiently melt ice/snow and frost adhering to the lens 1.

According to the present embodiment, since the heater unit 40, which generates a heat upon being energized, is provided between the flange portion 1b of the lens 1 and the flange portion 2b of the lens 2 within the lens barrel 10, it is possible to realize a snow melting function without increasing the size of the lens unit 100 (camera module 200).

Further, since an image captured will not be blurred by avoiding an adhesion of snow or the like to the lens 1, it is possible to prevent the imaging performance of the lens unit 100 from deteriorating. Therefore, for example, when the lens unit 100 is used in an in-vehicle camera, it is possible to prevent snow or the like adhering to the front surface of the lens 1 from affecting an automatic braking function, an automatic driving function, or the like. In this way, it is possible to provide a vehicle driver with a comfortable driving, thus ensuring a safety for all the occupants including the driver.

Next, the second embodiment of the present invention will be described as follows.

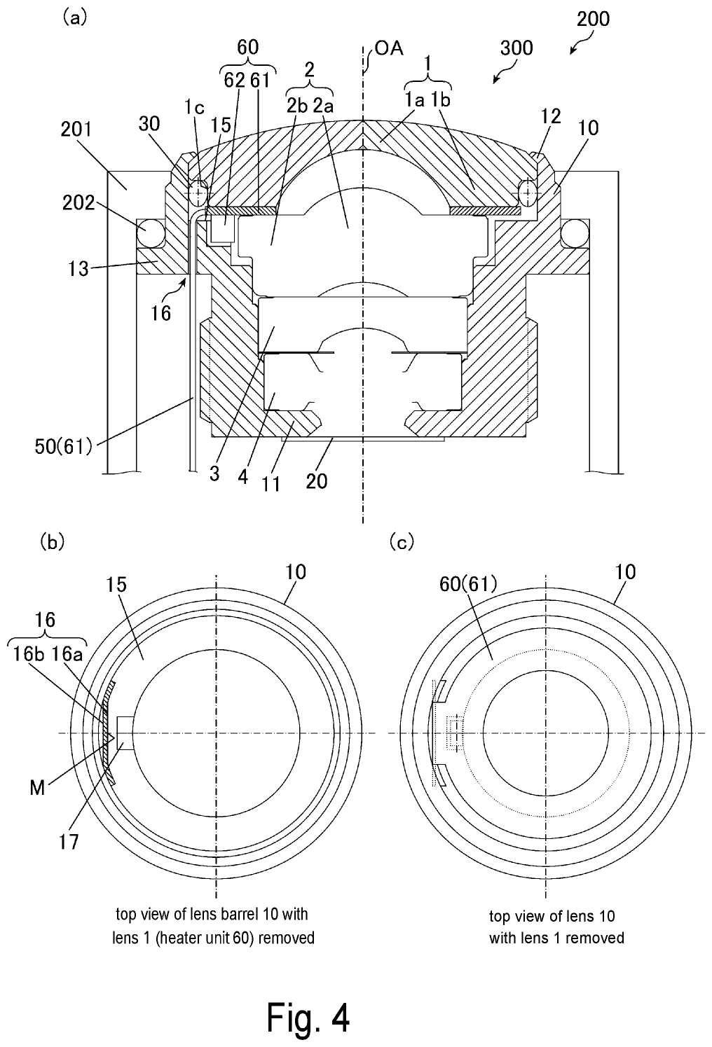

FIG. 4(a) is an axial sectional view of a lens unit 300 configured according to the second embodiment. On the other hand, in FIG. 4(a), hatching portions representing cross sectional portions are omitted. Hereinafter, configurations having the same or equivalent functions as those described in the first embodiment are represented by the same reference numerals, with the description thereof being omitted or simplified.

The lens unit 300 includes a heater unit 60. The heater unit 60 is sandwiched between the lens 1 and the lens 2.

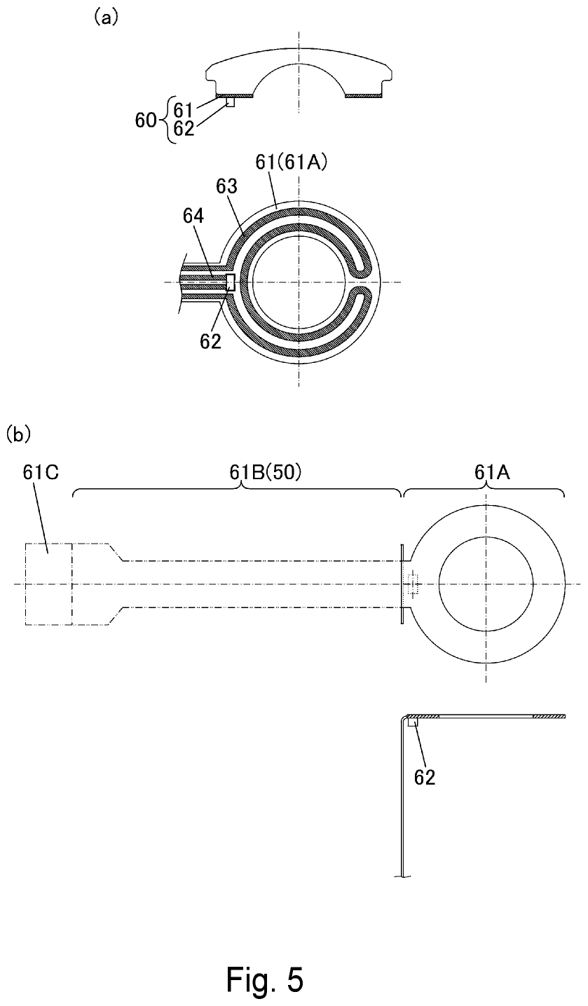

FIGS. 5 (a) and 5 (b) are diagrams for explaining the heater unit 60. The heater unit 60 includes an FPC (Flexible printed circuit) 61 and a thermistor 62. The FPC 61 is a flexible substrate. The material of FPC 61 is PET film or polyimide film. The FPC 61 is a film in which an electric circuit has been wired.

As shown in FIG. 5(b), the FPC 61 includes an annular portion 61A, a straight portion 61B, and an FPC connector portion 61C. A heater circuit 63 and a thermistor circuit 64 are formed in the annular portion 61A and the straight portion 61B. The heater circuit 63 and the thermistor circuit (wiring) 64 are made of materials each having a predetermined resistance, and a function of generating a heat when energized. In this embodiment, the heater circuit 63 and the thermistor circuit 64 are formed by printing the silver paste using a screen printing machine. The heater circuit 63 in the annular portion 61A is formed in a manner such that the wire width of circuit pattern is narrow to increase its resistance, thereby ensuring a function as a heater. On the other hand, the heater circuit in the straight portion 61B is formed in a manner such that its wire width is wide to reduce its resistance, thereby suppressing an amount of heat generated. Though in this embodiment, a silver paste is used as a useful material, it is also possible to use a carbon paste. Further, for the purpose of improving the precision of the circuit pattern, it is also possible to form a desired circuit pattern by etching a composite film formed by bonding a copper foil, an aluminum foil, a stainless foil or the like onto a polyimide film.

The Curie temperature of the heater unit 60 in such an arrangement is defined to a whole of the heater circuit 63, the thermistor circuit (wiring) 64, and the thermistor 62. Namely, when a temperature rises from a room temperature (25° C.) and then rises to or becomes higher than a certain value, the resistance will suddenly increase, and the temperature at which the resistance will be twice the resistance at 25° C. is defined as the Curie temperature.

The thermistor 62 is an electronic unit having a PTC function, and is also an element that shows a positive temperature coefficient when there is a rapid increase in electrical resistance due to an increase in temperature. The thermistor 62 has a substantially constant resistance near room temperature, but the resistance value will suddenly rise sharply when temperature exceeds a certain value. Generally, the thermistor 62 has such characteristics when a trace amount of rear earth elements has been added to barium titanate.

Chip type materials are widely used in the thermistor 62. The thermistor 62 detects an ambient temperature. When an ambient temperature rises to a specific value, the resistance will suddenly and sharply increase, thereby reducing an electric current flowing through the heater circuit 63. The thermistor 62 having such a characteristic is used in a constant temperature heating element, a heater unit or the like. Using the thermistor 62, it is possible to keep temperature at a constant value, without performing an ON/OFF control. For example, by inserting the thermistor 62 in series with the heater circuit 63, it is possible to control the current flowing through the heater circuit 63 without the need for a control circuit. In this embodiment, the thermistor 62 is arranged in the annular portion 61A and mounted on the thermistor circuit (wiring) 64, thereby ensuring an appropriate temperature control.

As another method, it is also possible to monitor a voltage applied to the thermistor 62 by using a monitor circuit, use a control circuit to perform an A/D conversion on the output of the monitor circuit, and input the converted signal into an internal microcomputer, hereby controlling a voltage which is to be applied to the heater circuit 63. In this way, it is possible to perform a temperature management with a high precision. On the other hand, it is also possible to configure a control circuit using an analog circuit rather than a digital circuit. Further, in an embodiment comprising such a monitor circuit and a control circuit, a certain temperature under temperature control that is equal to or lower than a predetermined temperature is regarded as Curie temperature.

In the present embodiment, the wiring portion 50 is composed of the straight portion 61B of the FPC 61. FPC connector portion 61C is provided at an end portion of the FPC 61 that is exposed to the outside of the lens barrel 10. The FPC connector portion 61C is connected to a heater control unit (not shown) configured on the camera case 201 side. Electric power is supplied to the heater circuit 63 and the thermistor circuit 64 via the FPC connector portion 61C.

Returning to FIG. 4(a), the wiring of the wiring portion 50 will be described as follows.

The stepped portion 15 of the lens barrel 10 is provided with holes 16 for communication between the inside of the lens barrel 10 and the outside of the lens barrel 10 in parallel with the axial direction of the lens barrel 10. The holes 16 are provided to guide the thin and flat film-like FPC 61 into the lens barrel 10. An opening positioned on the outer side of the lens barrel 10 and located in the hole 16 is provided at a position on the image side of the seal portion between the camera case 201 and the O-ring 202 in the axial direction of the lens barrel 10. Since the inside of the camera case 201 is ensured to be airtight, water does not enter the lens barrel 10 through the hole 16. As a result, it is not necessary to insulate the heater unit 60.

FIGS. 4(b) and 4(c) are diagrams for explaining the relationship between the hole 16 and the FPC 61. The hole 16 includes a first flat portion 16a and a second flat portion 16b parallel to each other. Here, as shown in FIG. 4 (b), a point on the surface of the stepped portion 15 and a point at the center in the width direction of the first flat portion 16a is defined as a point M. The first flat portion 16a is formed such that it is perpendicular to a line segment connecting the center of the lens barrel 10 and the point M on the surface of the stepped portion 15.

Further, the width of the hole 16 is determined according to the width of the wiring portion 50 (FPC61). As a result, the hole 16 allows the FPC 61 to be inserted through the hole 16.

When passing the FPC 61 through the hole 16, the FPC 61 is passed along the first flat portion 16a and the second flat portion 16b of the lens barrel 10, and the FPC 61 is bent at a substantially right angle at the end of the first flat portion 16a. In this way, the FPC 61 comes into contact with the end of the first flat portion 16a, and is bent at a substantially right angle, and electrically connects the inside and the outside of the lens barrel 10 through the hole 16. By providing the hole 16, electric power can be supplied via the FPC 61 to the inside of the lens barrel 10 having no space. With this configuration, the FPC 61 can be passed through the lens barrel 10 with a minimum space, thereby realizing a miniaturization for the lens barrel. Further, an O-ring 30 is disposed between the outer peripheral portion of the lens 1 and the inner peripheral surface of the lens barrel 10. Here, the O-ring 30 is compressed in the radial direction to ensure an airtightness. On the other hand, if the hole 16 is made to have a minimum size, it is possible to prevent the inner diameter of the lens barrel 10 from expanding (which will be caused by a repulsive force of the O-ring 30), thereby maintaining an airtightness.

Next, a location for mounting the thermistor 62 will be described as follows.

As shown in FIG. 5(a), the thermistor 62 is mounted on the image side surface of the annular portion 61A of the FPC 61. As shown in FIG. 4(a), the position of the thermistor 62 in the radial direction is a position inside the outer diameter of the lens 1, which is also a position outside the outer diameter of the lens 2. Here, the diameter of the lens 2 is smaller than the diameter of the lens 1. The position of the thermistor 62 with respect to the axial direction is within the range of the thickness width of the lens 2.

As shown in FIG. 4(b), the lens barrel 10 at a position facing the thermistor 62 is provided with a recess (concave portion) 17 having a concave shape for accommodating the thermistor 62. Therefore, the thermistor 62 is accommodated inside the recess 17 without interfering with the lens barrel 10. As a result, it is possible to amount the thermistor 62 in a small space without increasing the size of the lens barrel 10. Namely, this configuration in which the recess 17 is provided to accommodate the thermistor 62 contributes to the realization of miniaturization of the lens unit 300 and the camera module 200.

Regarding an ultra-wide-angle lens, if it is desired to ensure a horizontal angle of view exceeding 180°, it is preferable that a distance (gap) between the flange portion 1b of the lens 1 and the flange portion 2b of the lens 2 is 0.05 mm or more and 0.5 mm or less. If the distance exceeds 0.5 mm, the horizontal angle of view becomes less than 180°, making it difficult to realize an ultra-wide angle. On the other hand, if the distance is less than 0.05 mm, it will be difficult to sandwich the heater unit 60 between the lens 1 and the lens 2. In the present embodiment, since the thickness of the heater unit 60 in the axial direction is about 0.2 mm, and since the distance is 0.5 mm or less, it has been made exactly possible that the horizontal angle of view is larger than 180°

The heater unit 60 is in contact with the lens 1 and the lens 2. When electric power is supplied to the heater unit 60 via the wiring portion 50, the heater unit 60 generates a heat when energized. The heat of the heater unit 60 is then transferred to the lens 1 and the lens 2. When the temperature of the lens 1 rises, the ice and snow or frost adhering to the object-side surface of the lens 1 (front surface of the lens 1) will melt.

In the present embodiment, the image-side surface of the flange portion 1b of the lens 1 is painted with a black ink to realize a light-blocking function. Here, the black painting may be performed by using, for example, a black paint.

In the above it has been described that the heater unit 60 is sandwiched between the lens 1 and the lens 2, it is also possible for the heater unit 60 to be bonded to the lens 1 via an adhesive or the like having a high thermal conductivity.

According to the present embodiment, as in the first embodiment, it is possible to realize the snow melting function, without causing an increase in the size of the lens unit 300 (camera module 200). Further, since an image captured is not blurred (which will otherwise happen due to the adhesion of snow or the like to the lens 1), it is possible to prevent a deterioration in the imaging performance of the lens unit 300. Further, since the heater unit 60 is configured to include the thermistor 62 in the lens barrel 10, it is possible to realize a heater unit 60 having a PTC function without causing an increase in size. Further, since the heater unit 60 has the PTC function, it is possible for temperature to be controlled at a constant value without performing another special control.

Moreover, since the thickness of the heater unit 60 located between the lens 1 and the lens 2 is set to be 0.5 mm or less, it is possible to realize an ultra-wide-angle lens having a horizontal angle of view which is larger than 180°.

Next, the third embodiment of the present invention will be described as follows.

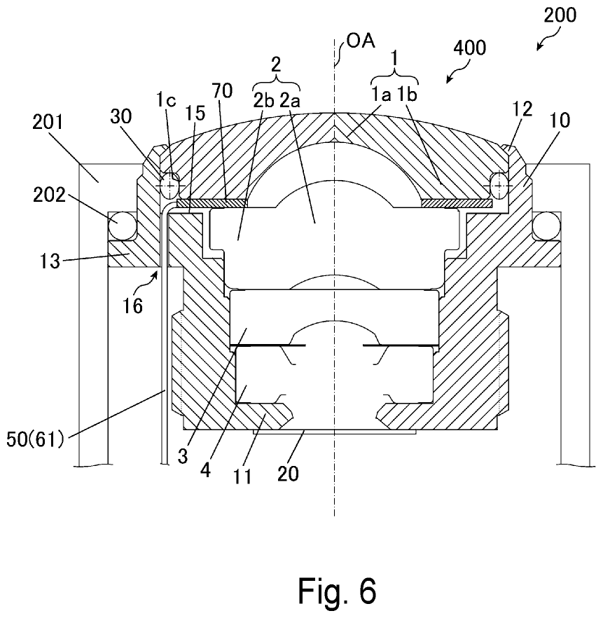

FIG. 6 is an axial sectional view of a lens unit 400 according to the third embodiment. However, some hatching portions representing cross section portions are omitted. Hereinafter, configurations having the same or equivalent functions as those described in the first embodiment and the second embodiment are indicated by the same reference numerals, and the descriptions thereof will be omitted or simplified.

The lens unit 400 includes a heater unit 70. The heater unit 70 is sandwiched between the lens 1 and the lens 2.

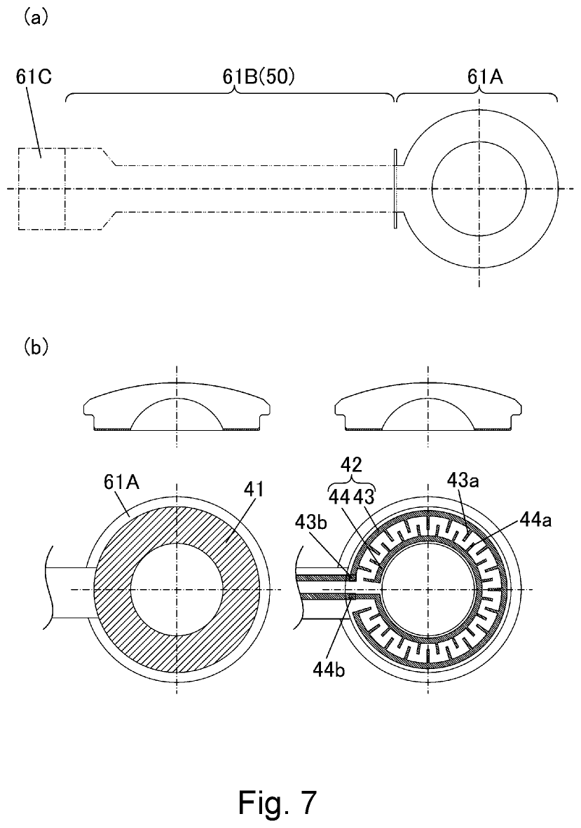

FIGS. 7(a) and 7 (b) are diagrams for explaining the heater unit 70.

The heater unit 70 includes an FPC 61 made of a PET film, a conductive carbon film 41, and a circuit pattern 42. The FPC 61 includes an annular portion 61A, a straight portion 61B, and an FPC connector portion 61C. The conductive carbon film 41 is printed on the annular portion 61A, and a comb-shaped circuit pattern 42 is printed on the conductive carbon film 41. The conductive carbon film 41 has a light-blocking function and a PTC function. Further, in the present embodiment, the wiring portion 50 is composed of the straight portion 61B of the FPC 61. The conductive carbon film 41 and the circuit pattern 42 can be manufactured by the same technique as in the first embodiment.

A conducting circuit (not shown) is formed in the straight portion 61B of the FPC 61, and the conducting circuit and the end portions 43b, 44b of the circuit pattern 42 are electrically connected to each other. Electric power is supplied to the conducting circuit via the FPC connector portion 61C.

In the present embodiment, the thickness of the heater unit 70 in the axial direction is about 0.215 mm. In this way, it is possible to ensure a horizontal angle of view which is larger than 180°.

According to the present embodiment, as in the first embodiment and the second embodiment, the snow melting function can be realized without causing an increase in the size of the lens unit 400 (camera module 200). Further, since an image captured is not blurred (which will otherwise be caused due to the adhesion of snow or the like to the lens 1), it is possible to prevent a deterioration in the imaging performance of the lens unit 400. In addition, the heater unit 70 having PTC function can be realized without causing an increase in size. In this way, since the heater unit 70 has PTC function, it is possible for temperature to be controlled at a constant value without performing another special control.

Further, since the thickness of the heater unit 70 located between the lens 1 and the lens 2 is set to be 0.5 mm or less, it is possible to realize an ultra-wide-angle lens having a horizontal angle of view which is larger than 180°.

Next, the fourth embodiment of the present invention will be described as follows.

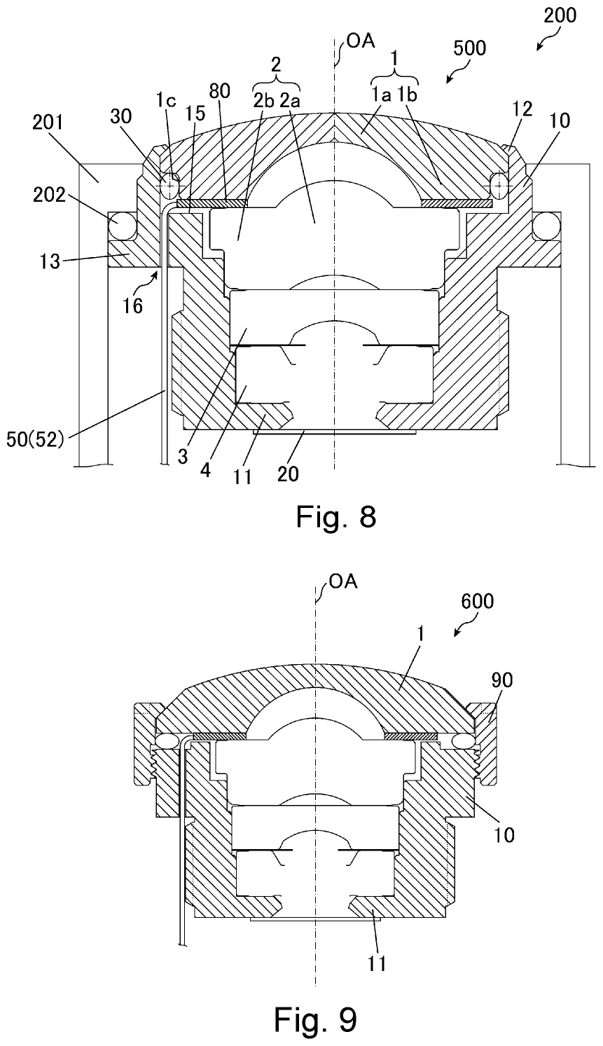

FIG. 8 is an axial sectional view of a lens unit 500 according to the fourth embodiment. However, some hatching portions representing cross section portions are omitted. Hereinafter, configurations having the same or equivalent functions as those described in the first embodiment to the third embodiment are indicated by the same reference numerals, and the descriptions thereof will be omitted or simplified.

The lens unit 500 includes a heater unit 80. The heater portion 80 is sandwiched between the lens 1 and the lens 2.

The heater unit 80 is made of ceramics containing barium titanate as a main component and has a PTC function. The ceramics have a Curie temperature (Curie point), and when the temperature exceeds the Curie temperature, the crystal system undergoes a phase transition from the tetragonal system to the cubic system, and the electrical resistance rises sharply. The heater unit 80 detects an ambient temperature, and when the temperature exceeds the Curie temperature, the resistance will sharply rise and the flowing current will be reduced. Therefore, it is possible to maintain a constant temperature without requiring an ON/OFF control. Here, the Curie temperature (Curie point) is defined as a temperature at which the resistance value is twice the resistance value at 25° C.

Further, an electrode (single-sided electrode) may be formed on the lens 1 side (glass lens side) surface of the heater unit 80. Such an electrode can be, for example, the comb-shaped circuit pattern 42 shown in FIG. 2 (a). In other words, the circuit pattern 42 may be formed on the ceramics containing barium titanate as a main component, thereby forming the heater unit 80.

Moreover, heat is also transferred to a surface opposite to an electrode forming surface so that the temperature rises. In this way, by heating the lens 1 side, it is possible to suppress the temperature rising on the lens 2 side. Namely, the heating is required to be performed on only the lens 1 side that requires heating. Further, since the electrode is formed on only one side, the thickness of the heater unit 80 can be reduced, making it possible to optimally ensure a horizontal angle of view which is larger than 180°.

In the present embodiment, the wiring portion 50 is composed of the lead wire 52. The lead wire 52 and the heater unit 80 are bonded to each other by, for example, soldering, and are electrically connected to each other.

Further, in the present embodiment, the image-side surface of the flange portion 1b of the lens 1 is painted with a black ink to realize a light-blocking function. Here, the black painting may be performed by using, for example, a black paint.

In the present embodiment, the thickness of the heater unit 80 in the axial direction is 0.5 mm. Therefore, it is possible to ensure a horizontal angle of view which is larger than 180°.

According to the present embodiment, as in the first to third embodiments, it is possible to realize the snow melting function without causing an increase in the size of the lens unit 500 (camera module 200). Further, since an image captured is not blurred (which will otherwise be caused due to the adhesion of snow or the like to the lens 1), it is possible to prevent a deterioration in the imaging performance of the lens unit 500. In addition, it is also possible to realize the heater unit 80 having PTC function without causing an increase in size. In this way, since the heater unit 80 has PTC function, it is possible for temperature to be controlled at a constant value without performing another special control.

Further, since the heater unit 80 located between the lens 1 and the lens 2 has a thickness of 0.5 mm or less, it is possible to realize an ultra-wide-angle lens having a horizontal angle of view which is larger than 180°.

Moreover, according to the first to fourth embodiments, since the heater units 40, 60, 70, 80 are provided at the positions where they come into contact with the lens 1, it is possible to suppress an electric power consumption than an arrangement in which a heater unit and a fan are provided outside the lens barrel 10.

Besides, in the first to fourth embodiments, the lens barrel 10 is made of resin, and the lens barrel 10 is provided with a holding portion 12 formed by caulking. Next, description will be given to an example in which the lens barrel 10 is made of metal. For example, the lens barrel 10 is made of aluminum.

FIG. 9 is a cross-sectional view showing a lens unit 600 including a metal lens barrel 10 and a cap 90. The cap 90 is made of a metal such as aluminum.

A male screw portion is formed on the outer peripheral surface of the end portion of the lens barrel 10 on the object side. The cap 90 is attached to the male screw portion.

The cap 90 is annular in shape, and a female screw portion for screwing with the male screw portion of the lens barrel 10 is formed on the inner peripheral surface of the cap 90. The inner diameter of a portion of the cap 90 that comes into contact with the object-side surface of the lens 1 is smaller than the outer diameter of the lens 1.

The parts housed inside the lens barrel 10 are supported such that they are sandwiched between the support portion 11 and the cap 90. In other words, the parts housed inside the lens barrel 10 are held in a state of being pressed toward the support portion 11 by the cap 90. As a result, no gap is formed between the parts.

Further, in the second to fourth embodiments, generally, when an air layer is interposed between the heater units 60, 70 or 80 and the lens 1, there will be a deteriorated heat conductivity when a heat is transferred from the heater units 60, 70 or 80 to the lens 1. In this way, if a heat conductive sheet or a heat conductive adhesive material is interposed between a heat unit and lens, it is possible to efficiently transfer the heat from the heater units 60, 70 or 80 to the lens 1.

Next, a fifth embodiment of the present invention will be described as follows.

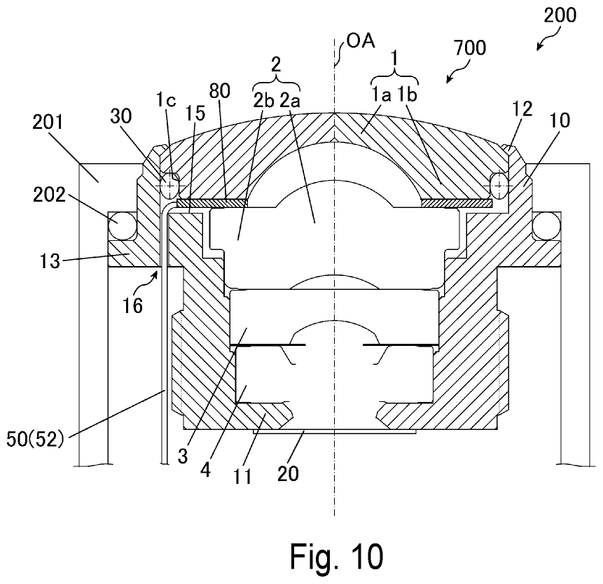

FIG. 10 is an axial sectional view of a camera module 200 according to the fifth embodiment. However, some hatching portions representing cross section portions are omitted. Hereinafter, configurations having the same or equivalent functions as those described in the first to the third embodiments are indicated by the same reference numerals, and the descriptions thereof will be omitted or simplified.

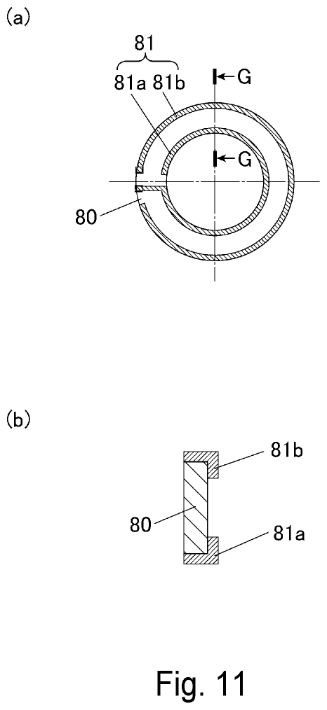

Similar to the fourth embodiment, a lens unit 700 according to the present embodiment includes a heater unit (doughnut-shaped ceramic heater) 80. In the heater unit 80 of the present embodiment, electrode 81 is formed (shown in FIG. 11). Further, a lead wire 52 (shown in FIG. 8) is adhesively fixed to the electrode 81 by, for example, soldering.

FIG. 11 (a) is a cross sectional view of the heater unit 80 (when viewed from the image side), and FIG. 11 (b) is an end sectional view taken along G-G line shown in FIG. 11(a).

The electrode 81 is composed of an inner peripheral side electrode pattern 81a and an outer peripheral side electrode pattern 81b. For example, the inner peripheral side electrode pattern 81a is a positive electrode and the outer peripheral side electrode pattern 81b is a negative electrode. The inner peripheral side electrode pattern 81a is provided in an annular shape along the inner peripheral portion and the inner peripheral side surface of the heater unit 80 on the image side thereof. Further, the outer peripheral side electrode pattern 81b is provided in an annular shape along the outer peripheral portion and the outer peripheral side surface of the heater unit 80 on the image side thereof. Moreover, lead wires 52 are respectively bonded to the end portion of the inner peripheral side electrode pattern 81a and the end portion of the outer peripheral side electrode pattern 81b by soldering or the like.

By providing the electrode 81 on the side surface of the heater unit 80 in this way, the contact area between the electrode 81 (inner peripheral side electrode pattern 81a and outer peripheral side electrode pattern 81b) and the heater unit 80 can be increased, thereby improving an adhesiveness between the two. Further, since the area of the electrode 81 becomes large, it is possible to prevent the resistance at the electrode 81 from becoming too large when energized. In addition, the heater unit 80 (ceramic heater) can be downsized, and the entire surface of the heater unit 80 can be heated more efficiently.

As described above, the heater unit 80 is made of ceramics containing barium titanate as a main component, and has a PTC function (PTC characteristic). Such ceramics has a Curie temperature (Curie point), and when the temperature exceeds the Curie point, the resistance rises sharply. Here, the Curie point is defined as a temperature at which the resistance is twice a resistance at room temperature (25° C.).

PTC (Positive Temperature Coefficient) is a characteristic (showing a positive temperature coefficient) in which an electrical resistance increases as the temperature rises. In general, PTC characteristic can be obtained by adding a small amount of rare earth element to barium titanate. Further, PTC characteristic is a characteristic in which the resistance will rapidly increase and the flowing current will be reduced when an ambient temperature is detected to have reached a specific temperature (detection temperature). Using such a characteristic, it is possible to have the temperature kept at a constant value without performing an ON/OFF control.

The Curie point of the heater unit 80 is preferably in a temperature range of 80−120° C. Namely, it is preferable that resistance of the heater unit 80 rises sharply in a temperature range of 80−120° C. With such configuration, the lens 1 (made of glass) located on the object side of the heater unit 80 can be heated in a short time from the start of energization, thereby realizing a snow melting function. Further, since the temperature of the heater unit 80 does not become too high, it is possible to prevent a deformation in the lens 2 (plastic lens) located on the image side of the heater unit 80, thereby preventing a deterioration in an optical performance of the lens unit (which will otherwise be caused due to the deformation of the lens 2). On the other hand, the heat resistance of the plastic lens is around 110° C., and if the temperature of the plastic lens is higher than 110° C., deformation may occur and the optical performance of the lens unit may deteriorate.

Further, if the Curie point is lower than 80° C., it takes a considerable time to melt the snow, and it is not possible to acquire a clear image in a short time after the start of energization of the heater unit 80. An effect of snow melting is required to appear to the extent that humans can visually confirm the snow melting 30 seconds after the start of snow melting (start of energization of the heater unit 80). Moreover, it is required that an effect of snow melting be sufficiently exhibited 60 seconds after the start of snow melting. A time period of 60 seconds is regarded as an average time required to suppress a dangerous driving which is caused by starting the vehicle before sufficient snow melting. From this viewpoint, the Curie point is preferably 80° C. or higher.

Further, when the Curie point is higher than 120° C., a time effect until snow melting will be extremely high, but there will be an unfavorable effect on the lens (particularly, the plastic lens 2 adjacent to the image side of the heater unit 80) and the lens barrel 10. Specifically, so-called unfavorable effect refers to a deformation in the lens 2, a deformation in the lens barrel 10, a cracking in an antireflection film coated on the surface of the lens 2, and the like, usually causing a deterioration in the optical performance of the lens unit. Further, if the Curie point is made higher than 120° C., the power consumption becomes large, it will be necessary to increase a voltage to be supplied to the heater unit 80. However, in an environment where a battery capacity is limited (such as in a vehicle), the voltage cannot be increased in view of other devices, and if the voltage is increased, a voltage drop may occur.

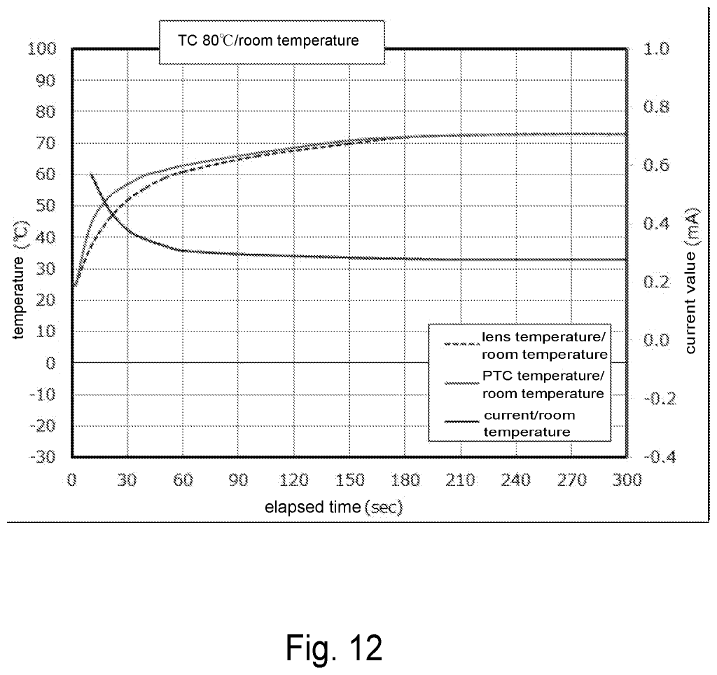

FIG. 12 is a graph showing a relationship among a current value [mA] supplied to the heater unit 80, an elapsed time [sec] from the start of energization, and surface temperatures [° C.] of the lens 1 and the heater unit 80, all when the heater unit 80 having a Curie point of 80° C. is energized at a room temperature (25° C.). Here, the surface temperature of the lens 1 is a temperature of the lens 1 (made of glass) on the object side thereof and is the temperature of a surface exposed to the outside of the vehicle.

As shown in FIG. 12, if a Curie point is 80° C. and an environment temperature is equal to a room temperature, the surface temperature of the lens 1 will reach to about 52° C. after 30 seconds and will reach to about 60° C. after 60 seconds. Further, when about 150 seconds have passed from the start of energization, the current value will become substantially constant, the rising in the surface temperature of the lens 1 will be suppressed at about 73° C.

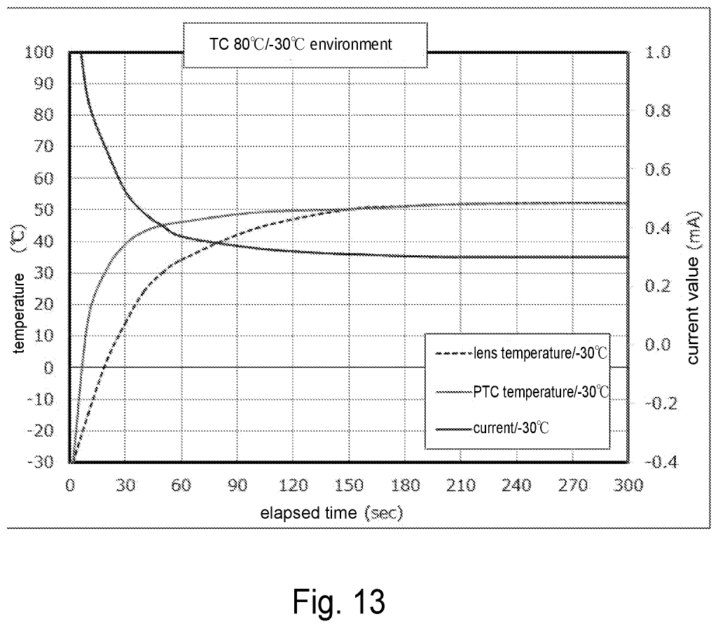

FIG. 13 is a graph showing a relationship among a current value [mA] supplied to the heater unit 80, an elapsed time [sec] from the start of energization, and surface temperatures [° C.] of the lens 1 and the heater unit 80, all when the heater unit 80 having a Curie point of 80° C. is energized at an environment temperature of −30° C.

As shown in FIG. 13, when a Curie point is 80° C. and an environment temperature is −30° C., the surface temperature of the lens 1 will reach about 13° C. after 30 seconds and will reach about 33° C. after 60 seconds. Further, when about 150 seconds have passed from the start of energization, the current value will become substantially constant, the rising in the surface temperature of the lens 1 can be suppressed, and the current value will become constant at about 50° C.

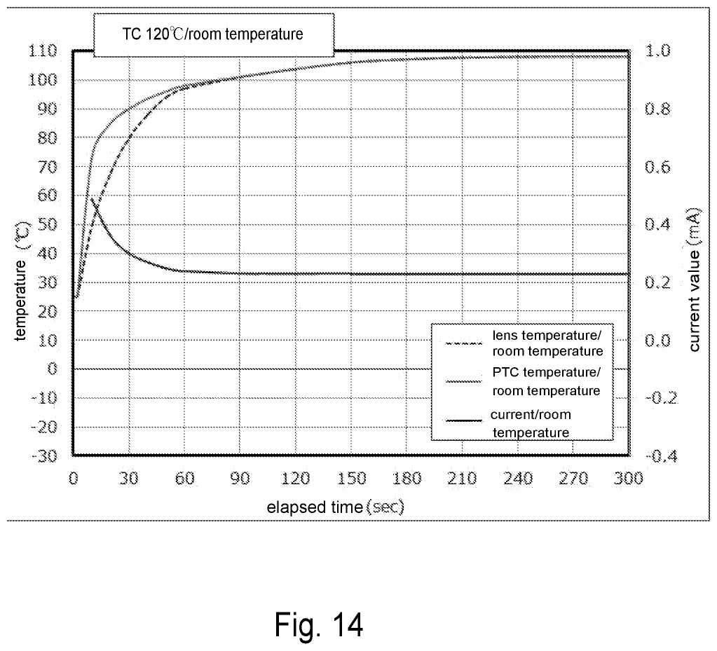

FIG. 14 is a graph showing a relationship among a current value [mA] supplied to the heater unit 80, an elapsed time [sec] from the start of energization, and surface temperatures [° C.] of the lens 1 and the heater unit 80, all when the heater unit 80 having a Curie point of 120° C. is energized at a room temperature (25° C.)

As shown in FIG. 14, if a Curie point is 120° C. and an environment temperature is equal to a room temperature, the surface temperature of the lens 1 will reach to about 80° C. after 30 seconds and will reach to about 96° C. after 60 seconds. Further, when about 150 seconds have passed from the start of energization, the current value will become substantially constant, the rising in the surface temperature of the lens 1 will be suppressed at about 109° C.

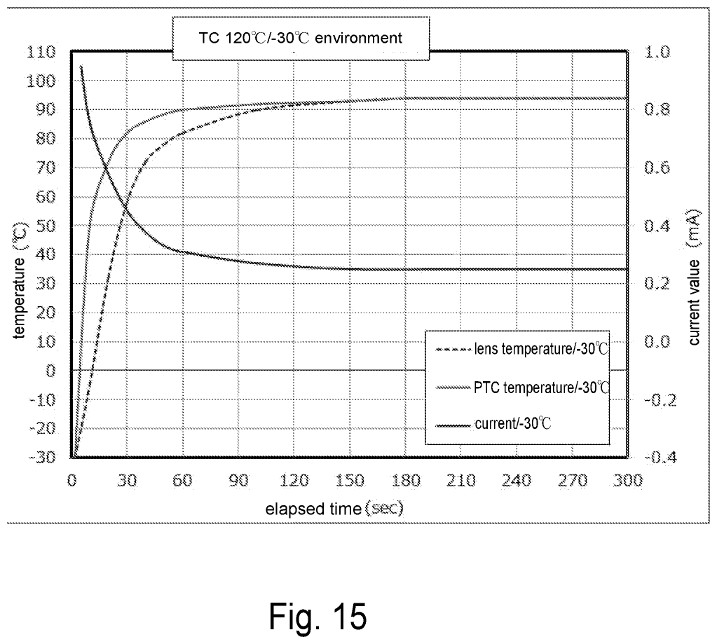

FIG. 15 a graph showing a relationship among a current value [mA] supplied to the heater unit 80, an elapsed time [sec] from the start of energization, and surface temperatures [° C.] of the lens 1 and the heater unit 80, all when the heater unit 80 having a Curie point of 120° C. is energized at an environment temperature of −30° C.

As shown in FIG. 15, if a Curie point is 120° C. and an environment temperature is −30° C., the surface temperature of the lens 1 will reach to about 55° C. after 30 seconds and will reach to about 82° C. after 60 seconds. Further, when about 150 seconds have passed from the start of energization, the current value will become substantially constant, the rising in the surface temperature of the lens 1 will be suppressed at about 92° C.

If the Curie point of the heater unit 80 is within the range of 80−120° C., the surface temperature of the lens 1 adjacent to the object side can be set to a temperature at which snow melting can be achieved within 60 seconds, thereby realizing the snow melting. Meanwhile, since the temperature of the plastic lens 2 adjacent to the image side does not reach 110° C. or higher, it is possible to prevent a deterioration in the optical performance (which will otherwise be caused due to deformation of the lens 2).

A voltage to be applied to the heater unit 80 is, for example, 6 [V]. If a higher voltage is applied to the heater unit 80, a time required to reach the Curie point can be shortened, making it possible to shorten a time required to complete the snow melting. On the other hand, if a camera module including the heater unit 80 is mounted in a car, it will be difficult to increase the voltage in view of other devices mounted in the car, causing a possibility that a voltage drop may occur if the voltage has been increased. However, if a voltage to be applied to the heater unit 80 is set at a lower voltage, there will be a possibility that the Curie point may not be reached and the snow melting time may become longer.

Next, description will be given to explain how to pull out the lead wire (conducting wire) 52 from the lens barrel 10.

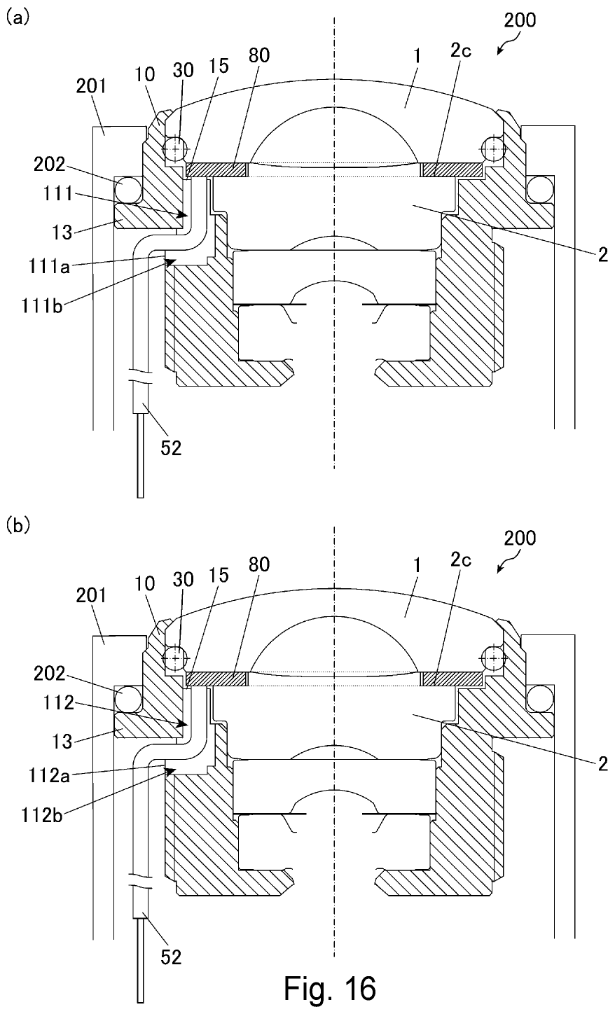

FIG. 16(a) is an axial sectional view of the camera module 200 on a plane passing through a through hole 111 (which will be described later), and FIG. 16(b) is also an axial section view of the camera module 200 on a plane passing through a through hole 112 (which will be described later).

A stepped portion 15 which is a surface perpendicular to the axial direction, is formed at a boundary portion between the lens 1 and the lens 2 of the lens barrel 10.

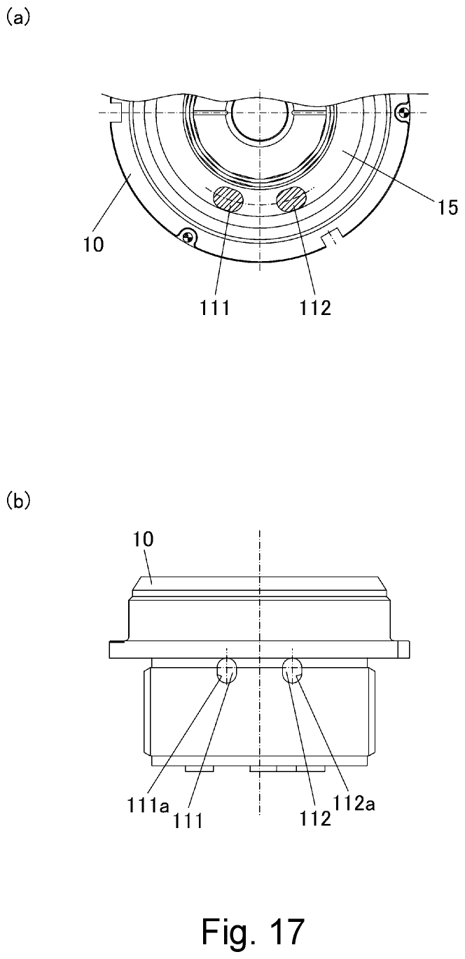

Further, FIG. 17 (a) is a view showing a part of the lens barrel 10 when seen from the object side, and FIG. 17(b) is a view showing the lens barrel 10 when seen from one side thereof. The stepped portion 15 is provided with two through holes 111, 112 for guiding (pulling out) the lead wires 52 to the outside of the lens barrel 10. One through hole is used for passing the positive electrode and the other through hole is used for passing the negative electrode. Here, through holes 111, 112 are formed each having a substantially elliptical shape in its cross section. However, this should not form any limitation to the shapes of the through holes 111, 112 and it is possible for each through hole to have a circular shape in its cross section.

As shown in FIG. 16, the through holes 111, 112 are formed in a manner such that a portion along the axial direction and a portion along the radial direction are orthogonal to each other, forming a substantially L-shaped cross section.

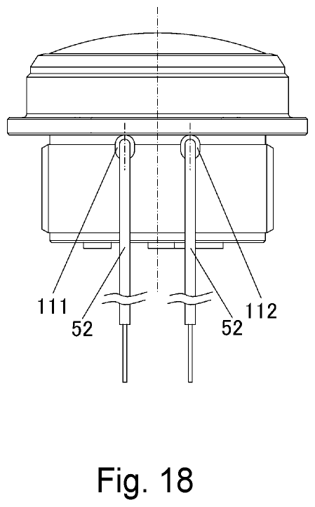

FIG. 18 is a side view of the lens unit in a state where the lead wires 52 are pulled out. These lead wires 52 are inserted one by one through the through holes 111, 112.

As shown in FIG. 16(a), one lead wire 52 is arranged with one end thereof connected to the heat unit 80 and the other end thereof pulled out through the through hole 111. Further, as shown in FIG. 16(b), another lead wire 52 is arranged with one end thereof connected to the heat unit 80 and the other end thereof pulled out through the through hole 112.

Hereinafter, as shown in FIG. 16, among the openings of the through holes 111, 112, the openings located on the outer peripheral surface of the lens barrel 10 are referred to as openings 111a, 112a. Further, the portions of the throughholes 111, 112 which are located at the openings 111a, 112a side in the internal spaces thereof are referred to as lead wire lead-out portions (openings) 111b, 112b.

As shown in FIG. 16, an O-ring 202 is arranged between the camera case 201 and the flange portion 13 formed on the outer peripheral surface of the lens barrel 10, thus forming a seal portion. At this time, the openings 111a, 112a will be located at positions on the image side of the seal portion between the camera case 201 and the O-ring 202 in the axial direction of the lens barrel 10. If the openings 111a, 112a are set in such positions, the interior (inside) of the camera case 201 can be made airtight. Therefore, it is possible to prevent water from invading into the barrel 10 through the openings 111a, 112a on the outer peripheral surface of the barrel 10. As a result, it is not necessary to insulate the heater unit 80. Further, since it is not necessary to insulate the heater unit 80, it is possible to realize a low cost.

Further, if through holes 111, 112 are not formed to be mutually parallel round holes when viewed from the axial object side shown in FIG. 17(a), and if the respective round holes are formed into groove shape (U-shaped groove when viewed from the axial object side) for communicating with the internal spaces of the barrel 10, further if two through holes are brought close to each other and combined to form one elongated hole, a result will be a deterioration in the rigidity of the lens barrel 10. Namely, though the interior of the lens barrel 10 will always be subjected to an outward force facing in the radial direction due to the O-ring 30 (see FIG. 16), if such force is received, the outer peripheral surface of the lens barrel 10 will be bent outwardly in the radial direction. Then, when the outer peripheral surface of the lens barrel 10 is bent outwardly in the radial direction, the airtightness of the seal portion (O-ring 30) will become low, and there will be a possibility that water or the like may enter the lens barrel 10. On the other hand, if the through holes are substantially round holes and are provided at two separated locations (namely, if the two through holes 111, 112 are provided), since a certain shape of material is existing between the through holes and the interior of the barrel 10 or between the through holes themselves, there will be no deterioration in the rigidity of the barrel 10. As a result, it is possible to prevent the problems described above.

Further, if a joint strength between the lead wires 52 and the heater unit 80 is low, and if the lead wires 52 are pulled out in the manufacturing process of the camera module, there will be a possibility that the lead wires 52 will come off the heater unit 80. Accordingly, the lead wire lead-out portions 111b, 112b can be filled with an adhesive (for example, ultraviolet curable resin) as a fixing material, thereby fixing the lead wires 52. As a result, even if the lead wires 52 are pulled, it is still possible to prevent a force from being directly applied to the joint portion between the lead wires 52 and the heater unit 80, and it is also possible to improve a pulling tolerance of the lead wires 52, without having to increase the joint strength between the lead wires 52 and the heater unit 80. Namely, even if the lead wires 52 are pulled, it is still possible to prevent the lead wires 52 from coming off the heater unit 80.

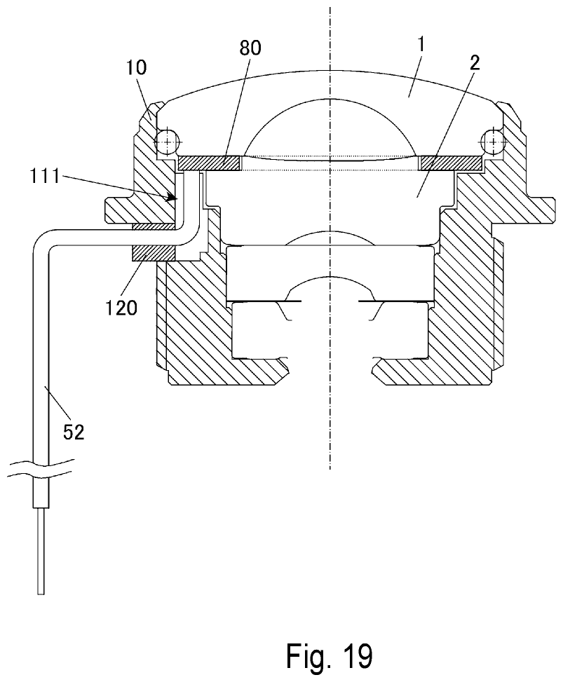

In addition, a fluororesin electric wire such as PTFE may be used as the lead wire 52. Although such fluororesin electric wire has an excellent solder heat resistance, it also has an excellent chemical resistance, making it difficult to be bonded somewhere. Therefore, when a fluororesin electric wire is used as the lead wire 52, as shown in FIG. 19, it is possible to use a cylindrical fixing member 120 to fix the lead wire 52 to each of the lead wire lead-out portions 111b, 112b.

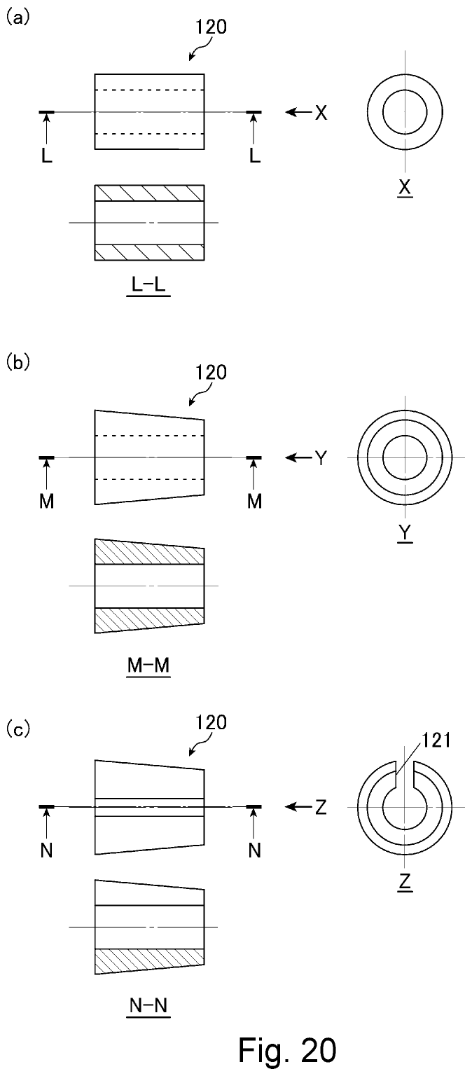

Here, the fixing member 120 will be described with reference to FIG. 20. FIG. 20(a) is a diagram showing the fixing member 120. FIGS. 20(b) and 20 (c) are diagrams showing a modified example of the fixing member 120.

The fixing member 120 shown in FIG. 20(a) is formed in a substantially cylindrical shape and has an outer diameter that can be inserted into the through holes 111, 112. Further, the inner diameter of the fixing member 120 is a diameter through which a lead wire 52 can be inserted. The material of the fixing member 120 is preferably the same as the material of the resin barrel 10. The resin is, for example, PA, PPS, or the like, and is a material that can be welded and adhered to the lens barrel 10. The lead wire 52 can be reliably fixed by inserting the lead wire 52 through the fixing member 120 and welding or adhering the fixing member 120 to the lens barrel 10 in a state where the fixing member 120 is inserted into each of the through holes 111, 112. In this way, even if the lead wire 52 is pulled, it is still possible to prevent the lead wire 52 from coming off the heater unit 80.

Each fixing member 120 shown in FIG. 20 (b) is formed into a tapered shape so that its outer diameter gradually decreases from one end thereof to the other. In particular, each fixing member 120 is made of an elastically deformable material such as rubber, and is inserted into each of the through holes 111, 112 from an end portion thereof having a smaller outer diameter. By making the outer peripheral surface of each fixing member 120 into a tapered shape, it becomes possible to more reliably push the fixing members 120 into the through holes 111, 112.

When the fixing members 120 are pushed into the through holes 111, 112, the outer diameter portions will be tightened (due to a force acting inwardly in the radial direction), while the inner diameter portions thereof will become smaller, so that the lead wires 52 will be tightened. In this way, each lead wire 52 can be securely fixed, and even when a lead wire 52 is pulled, it is still possible to prevent the lead wire 52 from coming off the heater unit 80. In fact, a larger outer diameter portion of a fixing member 120 will cause the inner diameter portion thereof to become smaller when being inserted into each of through holes 111, 112, thereby ensuring a larger force for tightening a lead wire 52. Further, when a fixing member 120 is made of an elastically deformable material, it is possible for the bonding or welding steps to become optional.

A fixing member 120 shown in FIG. 20 (c) is a member having a slit 121 formed along the axial direction in the fixing member 120 shown in FIG. 20 (b). By forming the slit 121 in this way, the outer diameter portion can be more easily tightened, and the inner diameter portion becomes correspondingly smaller in response to the slit width, so that the lead wire 52 can be more easily tightened.

In the camera module 200 shown in FIG. 16, the lens 1 is a glass lens and the lens 2 is a plastic lens. At the end of the flange portion 2b of the lens 2 on the object side, there is provided a reduced diameter portion 2c formed so as to have a diameter smaller than that of the image-side outer peripheral surface. In other words, the object-side surface of the lens 2 is provided so as to protrude from the object-side surface of the flange portion 2b with a step. Further, the inner diameter of the heater unit 80 is a diameter that can be fitted with the reduced diameter portion 2c (the protruding portion of the surface of the lens 2 on the object side). In this way, by fitting the heater unit 80 with the reduced diameter portion 2c, the heater unit 80 can be properly disposed while maintaining an inter-plane distance between the lens 1 and the lens 2. As a result, it is possible to ensure a wider angle of view for the camera.

Moreover, it is also possible for a heat conductive sheet having a thermal conductivity at least higher than that of the lens 1 to be interposed between the image side surface of the lens 1 and the heater unit 80. Preferably, the thermal conductivity of the heat conductive sheet is 0.5 [W/m·K] or more and 5.0 [W/m·K] or less. By interposing a heat conductive sheet, it is possible to improve the heat conductivity between the image side surface of the lens 1 and the heater unit 80. Further, for the purpose of suppressing a space between the lens 1 and the heater unit 80, it is preferable that the heat conductive sheet has a shore A hardness of at least 10 or more. If it is too soft, it will be impossible to ensure a size precision in the optical axis direction. Accordingly, shore A hardness is preferably 50 or less. By interposing a heat conductive sheet having such softness between the lens 1 and the lens 2, it is possible to suppress the cracking of the lens 1 due to the impact of pebbles colliding with the lens 1 when the vehicle is running. Further, it is preferable from the viewpoint of improving productivity that the heat conductive sheet and the lens 1 are bonded by interposing a double-sided tape having adhesive strength. The material of the double-sided tape is preferably a material that does not emit gas at high temperatures, such as acrylic.

On the other hand, it is also possible to interpose a heat insulating sheet having a thermal conductivity lower than that of the lens 2 between the surface of the lens 2 on the object side and the heater unit 80. By interposing a heat insulating sheet, for example, when the lens 2 is coated with an AR coating (antireflection film), it is possible to prevent the AR coating from being cracked due to a heat from the heater unit 80. Alternatively, by forming a textured surface on the object side of the lens 2 (flange portion of the lens 2) which is in contact with the heater unit 80, or forming a fine uneven shape to make the surface roughened, it is possible to reduce a contact area between the lens 2 and the heater unit 80, thereby suppressing a heat conduction from the heater unit 80 to the lens 2. Besides, it is also possible to use a heat insulating sheet at the same time.

In the fifth embodiment, the Curie point of the heater unit 80 is preferably within a range of 80−120° C., and this is true with all the above-described embodiments of the present invention. Further, the method of pulling out the lead wire (conducting wire) 52 from the lens barrel 10 described in the fifth embodiment is also applicable to all the embodiments of the present invention.

### EXPLANATIONS OF REFERENCE NUMERALS

1, 2, 3, 4 lens
10 lens barrel
40, 60, 70, 80 heater unit
41 conductive carbon film
42 circuit pattern
61 flexible substrate
62 thermistor
100,300,400,500 lens unit
200 camera module
52 lead wire
81a inner peripheral side electrode pattern
81b outer peripheral side electrode pattern
111,112 through hole (of the lens barrel)
111a, 112a opening (of the lens barrel)
111b, 112b (lens barrel) lead wire lead-out portion (openings)
120 fixing member

1. A lens unit including a cylindrical lens barrel and a plurality of lenses arranged side by side along an axial direction of the lens barrel on an inner peripheral side of the lens barrel, wherein
a heater unit that generates a heat when energized is provided between a flat portion of a first lens arranged on the most object side of the lens barrel and a flat portion of a second lens adjacent to the first lens.

2. The lens unit according to claim 1, wherein the heater unit includes:
a conductive carbon film having a self-temperature control function and a light-blocking function; and
a circuit pattern for energizing the conductive carbon film.

3. The lens unit according to claim 2, wherein the circuit pattern has a comb-like shape including a plurality of protruding portions protruding in the radial direction, and arranged at equal intervals along the circumferential direction.

4. The lens unit according to claim 1, wherein the heater unit includes:
a flexible substrate on which a heater circuit has been formed; and
a thermistor mounted on the flexible substrate and having a self-temperature control function.

5. The lens unit according to claim 1, wherein the heater unit includes:
a flexible substrate;
a conductive carbon film formed on the flexible substrate and having a self-temperature control function and a light-blocking function; and
a circuit pattern electrically connected to the flexible substrate and capable of energizing the conductive carbon film.

6. The lens unit according to claim 5, wherein the circuit pattern has a comb-like shape including a plurality of protruding portions protruding in the radial direction, and arranged at equal intervals along the circumferential direction.

7. The lens unit according to claim 1, wherein the heater unit is formed of ceramics having a self-temperature control function.

8. The lens unit according to claim 7, wherein the heater unit has a PTC characteristic, and has a Curie temperature which is 80° C. or higher and 120° C. or lower.

9. The lens unit according to claim 7, wherein the heater unit is formed in an annular shape, and includes:
an inner peripheral side electrode pattern provided along the inner peripheral portion and the inner peripheral side surface of the image side surface of the heater unit; and
an outer peripheral side electrode pattern provided along the outer peripheral portion and the outer peripheral side surface of the image side surface of the heater unit,
wherein lead wires are respectively adhered to the end portion of the inner peripheral electrode pattern and the end portion of the outer peripheral electrode pattern.

10. The lens unit according to claim 7, wherein lens barrel has a through hole for drawing a lead wire connected to the heater unit to the outside of the lens barrel through an opening formed on the outer peripheral surface of the lens barrel;
wherein the lead wire is fixed to the opening on the outer peripheral surface side of the lens barrel by an adhesive or a fixing member.

11. The lens unit according to claim 10, wherein there are two through holes provided in two positions, with one lead wire inserted into one through hole.

12. The lens unit according to claim 10,
wherein the fixing member is formed in a substantially cylindrical shape, and is inserted into the opening in a state where the lead wire has been inserted into the fixing member.

13. The lens unit according to claim 12, wherein the fixing member is formed in a tapered shape using an elastically deformable material, such that the outer diameter thereof becomes smaller from one end to the other, and is inserted into the opening from an end having a smaller diameter, with the inner diameter thereof becoming smaller while being inserted into the opening.

14. The lens unit according to claim 1, wherein the thickness of the heater unit is such that a distance between the flat portion of the first lens and the flat portion of the second lens is 0.5 mm or less,
wherein a plurality of the lenses form an ultra-wide-angle lens assembly having a horizontal angle of view which is larger than 180°.

15. A camera module comprising: a lens unit according to claim 1; and an imaging element that captures an image formed by the lens unit.

16. A camera module comprising:
a lens unit according to claim 10;
an imaging element that captures an image formed by the lens unit;
a camera case that covers the periphery of the lens unit while exposing an end of the lens unit on the object side,
wherein an O-ring is disposed between the camera case and the flange portion formed on the outer peripheral surface of the lens barrel to form a seal portion,
wherein the opening of the through hole on the outer peripheral surface side of the lens barrel is provided on the image side of the seal portion in the axial direction of the lens barrel.
